(19) United States
(12) Patent Application Publication
(10) Pub. No.: US 2025/0362992 A1
(43) Pub. Date: Nov. 27, 2025

(54) Data Storage Device with Queue Depth Tracking

(71) Applicant: Sandisk Technologies, Inc., Milpitas, CA (US)

(72) Inventors: Karin INBAR, Ramat Hasharon (IL); Amir SEGEV, Meiter (IL); Judah Gamliel HAHN, Ofra (IL)

(73) Assignee: Sandisk Technologies, Inc., Milpitas, CA (US)

(21) Appl. No.: 18/954,923

(22) Filed: Nov. 21, 2024

Related U.S. Application Data
(60) Provisional application No. 63/651,130, filed on May 23, 2024.

(51) Int. Cl. G06F 11/07

(52) U.S. Cl. CPC G06F 11/0772; G06F 11/0757; G06F 11/079

(57) ABSTRACT

By alerting a host device of the reason for an exceeded timeout threshold or potential timeout, the host is able to implement appropriate mitigation processes for the present circumstance of device failure. The reason of timeout may be determined based on a high queue depth and load, or actual device failure. To make the determination, the storage device may track and evaluate a total queue depth and most recent total command rate to predict an optimal time for the host to implement mitigation processes, such as rate-limiting or redirecting the I/O to a different storage device. The host may also supply a timeout threshold, where the storage device will alert the host when an internal estimate of the consumption rate exceeds the host-supplied threshold.

### CROSS-REFERENCE TO RELATED APPLICATIONS

This application claims benefit of U.S. Provisional Patent Application Ser. No. 63/651,130, filed May 23, 2024, which is herein incorporated by reference.

### BACKGROUND OF THE DISCLOSURE

### Field of the Disclosure

Embodiments of the present disclosure generally relate to mitigating command timeout in data storage devices, such as solid state drives (SSD).

### Description of the Related Art

Storage devices, such as SSDs, may be used in computers in applications where relatively low latency and high capacity storage are desired. For example, SSDs may exhibit lower latency, particularly for random reads and writes, than hard disk drives (HDDs). Typically, a controller of the SSD receives a command to read or write data from a host device to a memory device. Reading or writing data from a host device to a memory device may be based on a paired submission and completion queue mechanism. In SSDs, the submission queue and completion queues are allocated in the host memory.

Enterprise NVMe devices support many queues, often these queues are very deep. Future storage devices are expected to serve hosts that may queue tens of thousands of commands in hundreds of thousands of queues. Operating systems (e.g., Windows or Linux) track commands from submission to completion to ensure that the storage device(s) don't time out during read or write processes and reflect any failures back to the calling application or subsystem. Typically, a read command will stall the calling thread until it is returned, and the operating system will fail stalled input/output (1/O) commands after a timeout. An operating system may register a timeout based on a set of system parameters or driver parameters—e.g., elapsed time-regardless of aggregate queue depth.

A typical command processing latency in an enterprise system may be up to tens of milliseconds (ms). Therefore, when serving many hosts and commands, compounding command processing latency may trigger a timeout which may be perceived by the calling thread as a device failure. Depending on the origin of the I/O and system configuration, the timeout and subsequent perceived device failure may lead to a retry, a system exception, or a device reset which does not resolve the command processing latency issue.

Currently, host devices often use shallow submission queues to prevent time out; however, this approach sacrifices the potential performance of the system. Additionally, in multi-tenant systems, a host hypervisor has less control over the behavior of each of the tenants. Other methods, such as the implementation of traffic shaping at the host queue may lead to device under-utilization. While increasing timeout threshold values may decrease the probability of triggering a timeout, this may lead to a delayed determination of actual device failure.

Thus, there is a need for an improved method to mitigate command traffic in data storage devices, such as solid state drives (SSD)

### SUMMARY OF THE DISCLOSURE

By alerting a host device of the reason for an exceeded timeout threshold or potential timeout, the host is able to implement appropriate mitigation processes for the present circumstance of device failure. The reason of timeout may be determined based on a high queue depth and load, or actual device failure. To make the determination, the storage device may track and evaluate a total queue depth and most recent total command rate to predict an optimal time for the host to implement mitigation processes, such as rate-limiting or redirecting the I/O to a different storage device. The host may also supply a timeout threshold, where the storage device will alert the host when an internal estimate of the consumption rate exceeds the host-supplied threshold.

In one embodiment, a data storage device, including a memory device, and a controller coupled to the memory device, wherein the controller is configured to track a total queue depth of one or more host queues, wherein the total queue depth is a number of pending commands the data storage device can handle at a time, and tracking the total queue depth comprises modifying the total queue depth when at least one command is written to the one or more host queues; and determine whether to alert a host device based on the modified total queue depth.

In another embodiment, a data storage device, including a memory device, and a controller coupled to the memory device, wherein the controller is configured to track a total queue depth of one or more host queues, wherein the total queue depth is a number of pending commands the data storage device can handle at a time, and tracking the total queue depth including increasing the total queue depth when at least one command is written to a first host queue of the one or more host queues; and decreasing the total queue depth when at least one command is written to a second host queue of the one or more host queues; and determine a reason of a failure of the data storage device based on the total queue depth and a total command rate, wherein the total command rate is a number of commands processed by the data storage device per second (IOP/s).

In yet another embodiment, a data storage device, including means to store data; and a controller coupled to the means to store data, wherein the controller is configured to track a total queue depth of one or more of host queues, wherein the total queue depth is a number of pending commands the data storage device can handle at a time, and tracking the total queue depth includes increasing the total queue depth when at least one command is written to a first host queue of the one or more host queues; and decreasing the total queue depth when at least one command is written to a second host queue of the one or more host queues; determine a reason of a failure of the data storage device based on the total queue depth and a total command rate, wherein the total command rate is a number of commands processed by the data storage device per second (IOP/s); alert a host device based on the determining; and receive at least one mitigation measure from the host device, the at least one mitigation measure including rate-limiting the host device; and redirecting the at least one command to another data storage device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a block diagram illustrating a method of operating a storage device to execute a read or write command, according to one or more embodiments.

FIG. 3 is a schematic block diagram illustrating a queueing system for storage I/O, according to one or more embodiments.

FIG. 4 is a block diagram illustrating a method of managing an internal queue of a storage device, according to one or more embodiments.

FIGS. 5A-5B are flowcharts illustrating a queue depth tracking process, according to one or more embodiments.

FIG. 6 is a flowchart illustrating a queue depth tracking process, according to one or more embodiments.

FIG. 7 is a flowchart illustrating a timeout mitigation process, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

By alerting a host device of the reason for an exceeded timeout threshold or potential timeout, the host is able to implement appropriate mitigation processes for the present circumstance of device failure. The reason of timeout may be determined based on a high queue depth and load, or actual device failure. To make the determination, the storage device may track and evaluate a total queue depth and most recent total command rate to predict an optimal time for the host to implement mitigation processes, such as rate-limiting or redirecting the I/O to a different storage device. The host may also supply a timeout threshold, where the storage device will alert the host when an internal estimate of the consumption rate exceeds the host-supplied threshold.

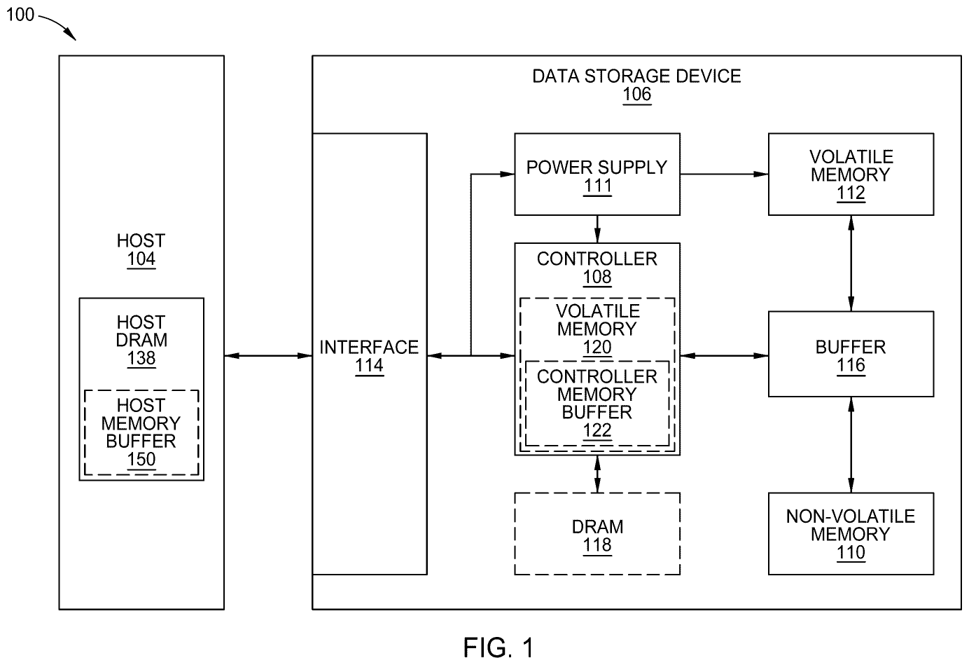

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe×1, ×4, ×8, ×16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVMe Flash memory devices may include NAND or NOR-based flash memory devices and may store data based on a charge contained in a floating gate of a transistor for each flash memory cell. In NVMe flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVMe cells. Rows of NVMe cells may be electrically connected using a word line to define a page of a plurality of pages. Respective cells in each of the plurality of pages may be electrically connected to respective bit lines. Furthermore, NVMe flash memory devices may be 2D or 3D devices and may be single level cell (SLC), multi-level cell (MLC), triple level cell (TLC), or quad level cell (QLC). The controller 108 may write data to and read data from NVMe flash memory devices at the page level and erase data from NVMe flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

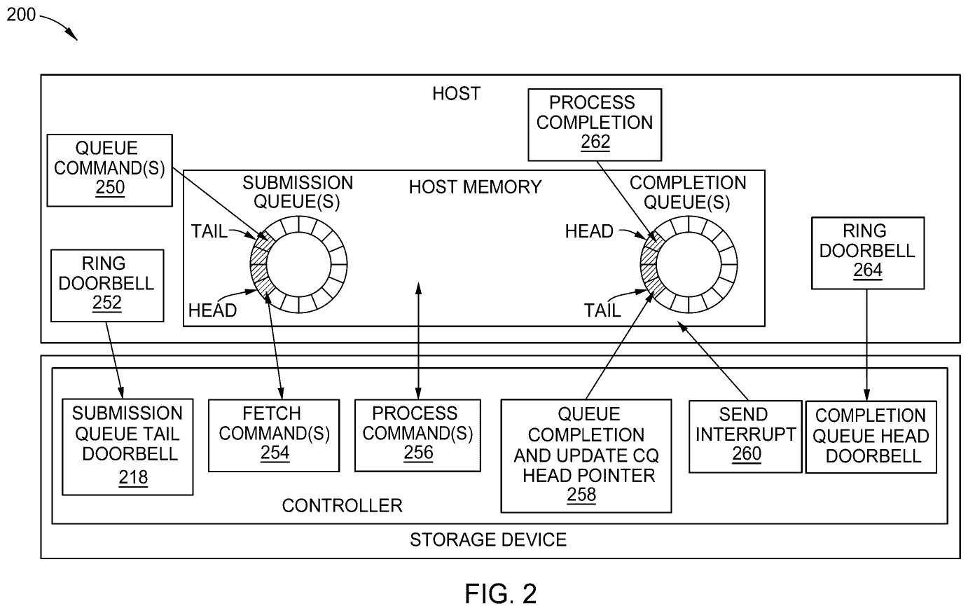

FIG. 2 is a block diagram illustrating a method 200 of operating a storage device to execute a read or write command, according to one embodiment. Method 200 may be used with the storage system 100 having a host device 104 and a data storage device 106 comprising a controller 108. Method 200 may be used with a host device and a storage device comprising a command processor.

Method 200 begins at operation 250, where the host device writes a command into a submission queue as an entry. The host device may write one or more commands into the submission queue at operation 250. The commands may be read commands or write commands. The host device may comprise one or more submission queues. The host device may write one or more commands to the submission queue in any order (i.e., a submission order), regardless of the sequential write order of the one or more commands (i.e., a sequential processing order).

In operation 252, the host device writes one or more updated submission queue tail pointers and rings a doorbell or sends an interrupt signal to notify or signal the storage device of the new command that is ready to be executed. The doorbell signal may be the doorbell 218 of FIG. 2. The host may write an updated submission queue tail pointer and send a doorbell or interrupt signal for each of the submission queues if there are more than one submission queues. In operation 254, in response to receiving the doorbell or interrupt signal, a controller of the storage device fetches the command from the one or more submission queue, and the controller receives or direct memory access (DMA) reads the command.

In operation 256, the controller processes the command and writes or transfers data associated with the command to the host device memory. The controller may process more than one command at a time. The controller may process one or more commands in the submission order or in the sequential order. Processing a write command may comprise identifying a zone to write the data associated with the command to, writing the data to one or more logical block addresses (LBAs) of the zone, and advancing a write pointer of the zone to identify the next available LBA within the zone.

In operation 258, once the command has been fully processed, the controller writes a completion entry corresponding to the executed command to a completion queue of the host device and moves or updates the CQ head pointer to point to the newly written completion entry.

In operation 260, the controller generates and sends an interrupt signal or doorbell to the host device. The interrupt signal indicates that the command has been executed and data associated with the command is available in the memory device. The interrupt signal further notifies the host device that the completion queue is ready to be read or processed.

In operation 262, the host device processes the completion entry. In operation 264, the host device writes an updated CQ head pointer to the storage device and rings the doorbell or sends an interrupt signal to the storage device to release the completion entry.

In some embodiments, queue commands are placed by the host device into a submission queue. Whereas, completion entries are placed into the associated completion queue by the device controller. In the queue model of non-volatile memory express (NVMe), a submitter of entries to a memory-based transport queue uses the current tail entry pointer to identify the next open queue slot. The submitter increments the tail entry pointer after placing the new entry to the open queue slot. If the tail entry pointer increments exceeds the queue size, the tail entry shall roll to zero. The submitter may continue to place entries in free queue slots as long as the queue is not full.

The consumer of entries on a memory-based transport queue uses the current head entry pointer to identify the slot containing the next entry to be consumed. The consumer increments the head entry pointer after consuming the next entry from the queue. If the head entry pointer exceeds the queue size, the head entry pointer shall roll to zero. The consumer may continue to consume entries from the queue as long as the empty queue condition is not met.

The creation and deletion of memory-based transport submission queues and associated completion queues are required to be ordered correctly by the host device. The host device creates the completion queue before creating any association submission queue. Submission queues may be created at any time after the associated completion queue is created. The host device deletes all associated submission queues prior to deleting a completion queue. To abort all commands submitted to the submission queue, the host device issues a delete I/O submission queue command for that queue.

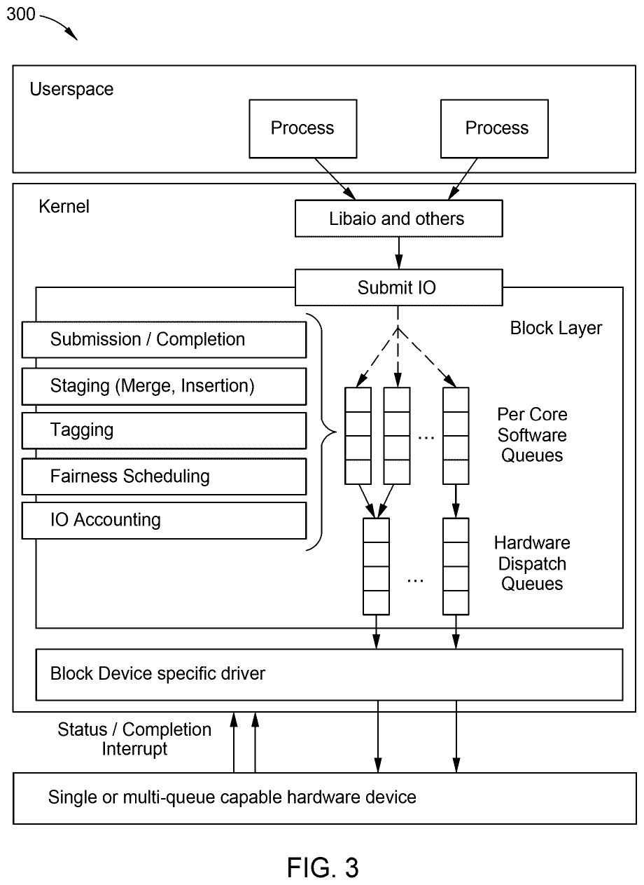

FIG. 3 is a schematic block diagram illustrating a queueing system 300 for storage I/O, according to one or more embodiments. Queueing system 300 may be part of an operating system (e.g., Linux or Windows). Queueing system 300 comprises multiple layers of queues that are managed by the operating system, the layers of queues are further attached to a set of corresponding hardware queues that are managed by a storage device (e.g., the storage device of FIG. 1).

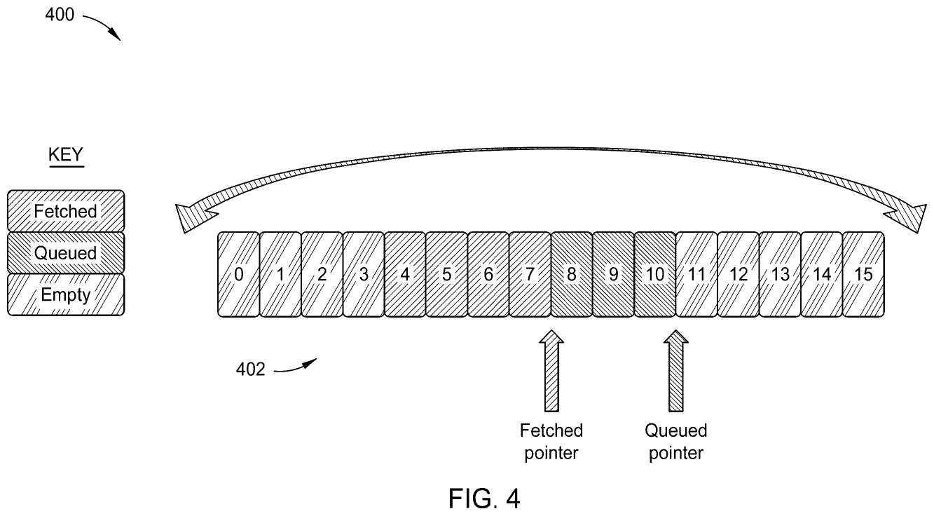

FIG. 4 is a block diagram illustrating a method 400 of managing an internal queue 402, according to one or more embodiments. The method 400 of managing internal queue 402 may be implemented on a storage device (e.g., storage device 106 of FIG. 1). Each command requires resources, even if it is just to fetch a command. Additionally, even more resources are needed to execute the command. As a result, the storage device will hold its own aggregate internal queue for commands. The storage device may be able to work on a number of commands in parallel. For example, the storage device may be able to work on 200 commands in parallel and may fetch from all its submission queues a number of commands less than or equal to the number of commands the storage device may be able to work on in parallel (e.g., 200 commands). The storage device will then wait for some of the fetched commands to execute before fetching new commands. However, this is not the queue depth seen by a host device (e.g., host device 104 of FIG. 1).

An internal queue of a storage device has a number of queue slots. As shown in FIG. 4, exemplary internal queue 402 has sixteen queue slots. At a current state, queue slots 0-3 are empty, the command(s) in queue slots 4-7 have been fetched, the command(s) in queue slots 8-10 are queued, and queue slots 11-15 are empty. A fetch pointer points to a next queue slot where a command is queued to be fetched and indicates the last queue slot of the fetched commands, in this example queue slot 8. A queue pointer points to the next queue slot that is empty (e.g., a “tail” of a queue), where a command may be written, and indicates the last queue slot of the queued commands. Conventionally, a host device can see the queued pointer but does not see the fetch pointer; therefore, the host device does not have any indicator of whether a command in the internal queue of the storage device is fetched or queued. Accordingly, the queue depth seen by the storage device is 4 (i.e., queue slots 4-8 are occupied), while the queue depth seen by the host-side queue is 7 (i.e., queue slots 4-10 are occupied).

Since the host cannot see the fetch pointer, a problem arises in systems that support storage devices with high queue depth. In enterprise systems that support many hosts that queue tens of thousands of commands in hundreds to thousands of queues, command processing latency is compounded and may trigger a timeout at certain times of high traffic. That is, a timeout may occur as a result of a very high queue depth; particularly, when a host device pushes commands faster than a storage device can process them. As the host generates traffic, it pushes commands into the queues. However, when the queues become full the host starts to back-pressure its traffic generation activities into the upper host queues.

Total queue depth is the number of pending I/O commands that a storage device can handle at any one time. The latency of the commands pending in a host submission queue is estimated by dividing a total queue depth by the current command processing rate (IOP/second). For example, if the total queue depth is 3000 and the command processing rate (or alternatively, total command rate) is 1000 IOP/s, then the controller estimates that it will take around 3 seconds to process all pending commands in the submission queue.

Ideally, a storage device will always be processing commands at the same rate, if not faster, as the submission queues are being filled. However, a system such as an enterprise system that creates a very high queue depth (e.g., a multi-tenant system) can generate commands faster than can be processed by the storage drive, and may observe very high command latencies, up to command timeout. Thus, a host device may perceive a device failure when the command processing latency causes the storage device to exceed a timeout threshold. For example, conventional timeout thresholds are typically set between 5 and 30 seconds, up to 60 seconds, regardless of aggregate queue depth. Device-level timeout is tracked at the NVMe submission queue level so depending on the origin of the I/O and system configuration, the perceived device failure due the timeout may lead to a retry, a system exception, or a device reset.

Further, a consumption rate of commands is the number of commands the storage device can complete in a given time and is dependent on a number of factors, including device performance, submission rate, host CPU and memory pressure, and internal priority. An application or a tenant in a multi-tenant system with corresponding virtual device(s) submitting commands is not aware of these factors and may flood the queues with commands. The flooding may lead to pending commands that exceed device design constraints and trigger application-level or system-level timeouts.

A determination of device failure based only on exceeding a timeout threshold regardless of aggregate queue depth may be good indicator of device failure in some circumstances. For example, when the storage device is able to process the commands at the rate that the host submits them, or when the total command queue depth is low, queue depth may be a good indicator. In some systems, such as enterprise systems, a command retry, a system exception, or drive level reset will not help to mitigate the timeout problem caused by high queue depth and load. Instead, the host device should implement mitigation processes to reduce the queue depth or command rate, such as rate-limiting or redirecting I/O commands to a different device. However, to apply the right mitigation processes for the appropriate circumstance, the host device should be allowed and able to distinguish the reason of the timeout. That is, if the timeout is a result of an actual drive failure (e.g., device malfunction) or merely a perceived device failure (e.g., a very high queue depth/load due to back-pressure).

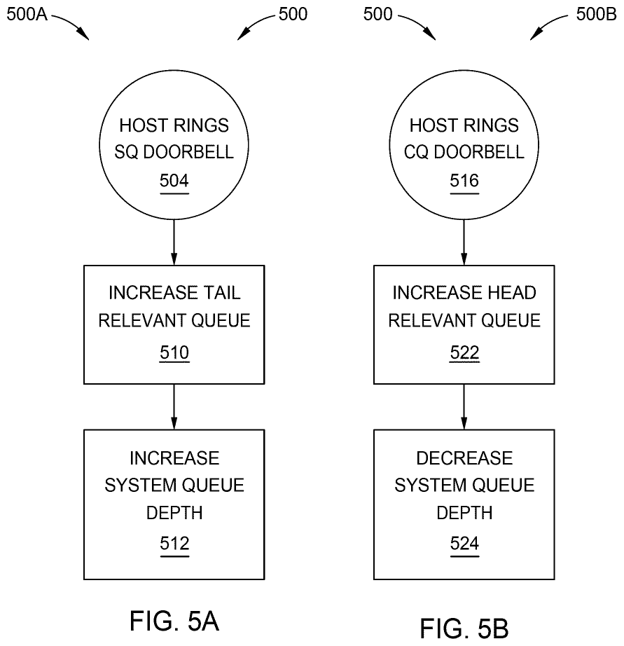

FIGS. 5A-5B are flowcharts illustrating a queue depth tracking method 500, according to one or more embodiments. FIG. 5A depicts a part of method 500 and illustrates a process 500A to track queue depth when the host device rings a submission queue doorbell. FIG. 5B depicts another part of method 500 and illustrates a process 500B to track queue depth when the host device rings a completion queue doorbell. In some embodiments, a storage device may be configured to implement either part of method 500, but not the other (e.g., a controller configured to implement process 500A but not process 500B, vice versa, or alternating). In some embodiments, method 500 is tracked using an internal queue (e.g., internal queue 402 of FIG. 4) stored in a storage device (e.g., storage device 106 of FIG. 1).

As shown in FIG. 5A, process 500A begins at operation 504, where a host writes one or more updated submission queue tail pointers and rings a submission queue doorbell after writing one or more commands into the submission queue as an entry (as described in FIG. 2). At operation 510, when a controller (e.g., controller 108 of FIG. 1) determines that the command is an Admin command or I/O command, and accordingly written to a corresponding Admin submission queue or I/O submission queue, the controller increases the tail of the relevant Admin queue or I/O queue. At operation 512, the controller will also increase the system's total queue depth to track the host's total number of host-queued commands across the submission queues visible to it.

As shown in FIG. 5B, process 500B beings at operation 516, where a host rings a completion queue doorbell after a command has been fully processed and written the completion entry corresponding to the executed command to the completion queue of the host device (as described in FIG. 2). At operation 522, when a controller (e.g., controller 108 of FIG. 1) determines that the executed command is an Admin command or I/O command, and accordingly written to a corresponding Admin completion queue or I/O completion queue, the controller increases the head of the relevant Admin queue or I/O queue. At operation 524, the controller also decreases the system's total queue depth to track the host's total number of host-queued commands across the submission queues visible to it.

During normal flow, the controller does not track the head and tail of each submission queue, and does not track whenever the head (e.g., during completion) or tail (e.g., during submission) is updated. By tracking the head and tail of each relevant queue (i.e., the Admin queue and I/O queue), the controller may track the valid range of submission queue entries by maintaining a fetch pointer between the host-supplied information submission queue tail pointer and the device-updated submission queue head pointer that shows which command entries were consumed and are now available. Fetched commands are those copied into a device-internal queue for processing, and in a conventional storage device, only commands that were fetched are evaluated. Thus, as a result of tracking the head and tail of each relevant queue, a total queue depth may be seen by the host-side device drivers.

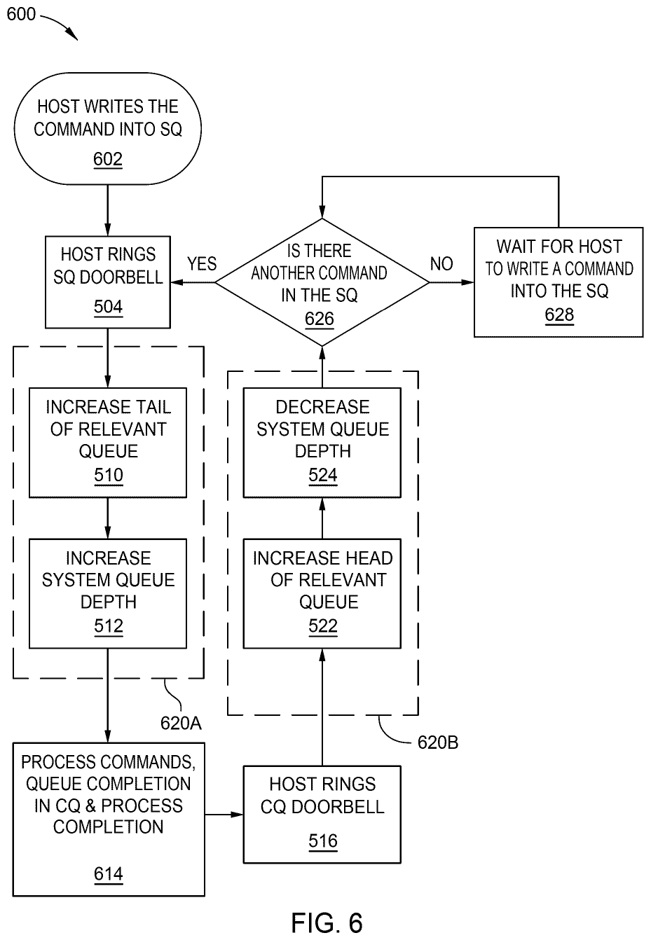

FIG. 6 is a flowchart illustrating queue depth tracking method 600, according to one or more embodiments. In some embodiments, method 600 is tracked using an internal queue (e.g., internal queue 402 of FIG. 4) stored in a storage device (e.g., storage device 106 of FIG. 1). By tracking a head and tail of relevant queues in one or more internal queues stored in a storage via queue depth tracking method 600 (more specifically, processes 602A, 620B), a total queue depth may evaluated by the storage device and shared with the host device to inform the host whether to implement mitigating processes based on whether a device failure is actual or perceived.

As shown in FIG. 6, method 600 begins at operation 602, where a host device writes a command into a submission queue as an entry. The host device may write one or more commands into the submission queue at operation 602. The commands may be read commands or write commands. The host device may comprise one or more submission queues. The host device may write one or more commands to the submission queue in any order (i.e., a submission order), regardless of the sequential write order of the one or more commands (i.e., a sequential processing order). As described in FIG. 5A, at operation 504, the host then rings a submission queue doorbell after writing one or more commands into the submission queue as an entry.

Process 620A comprises operations 510 and 512, and assists in tracking the system's total queue depth by increasing the total queue depth when I/O commands are written into the submissions queue. At operation 10, when the controller (e.g., controller 108 of FIG. 1) determines that the command is an Admin command or I/O command, and accordingly written to a corresponding Admin submission queue or I/O submission queue, the controller will increase the tail of the relevant Admin queue or I/O queue. At operation 512, the controller will also increase the system's total queue depth to track the host's total number of host-queued commands across the submission queues visible to it.

At operation 614, the controller processes the command and writes or transfers data associated with the command to the host device memory. The controller may process more than one command at a time. The controller may process one or more commands in the submission order or in the sequential order. Processing a write command may comprise identifying a zone to write the data associated with the command to, writing the data to one or more logical block addresses (LBAs) of the zone, and advancing a write pointer of the zone to identify the next available LBA within the zone. Once the command has been fully processed, the controller writes a completion entry corresponding to the executed command to a completion queue of the host device and moves or updates the CQ head pointer to point to the newly written completion entry. Once the host processes the completion entry, at operation 516, the host device writes an updated CQ head pointer to the storage device and rings the doorbell or sends an interrupt signal to the storage device to release the completion entry.

Process 620B comprises operations 522 and 524 and assists in tracking the system's total queue depth by decreasing the total queue depth when I/O commands are executed and written into the completion queue. At operation 522, when the controller determines that the executed command is an Admin command or I/O command, and accordingly written to a corresponding Admin completion queue or I/O completion queue, the controller will increase the head of the relevant Admin queue or I/O queue. At operation 524, the controller will also decrease the system's total queue depth to track the host's total number of host-queued commands across the submission queues visible to it.

At operation 626, the controller determines whether there are additional commands in the submission queue. If there are no commands in the submission queue, at operation 628, the controller will wait for the host to write a new command into the submission queue. If there is/are command(s) in the submission queue, at operation 504, the host writes one or more updated submission queue tail pointers and rings a submission queue doorbell after writing one or more commands into the submission queue as an entry.

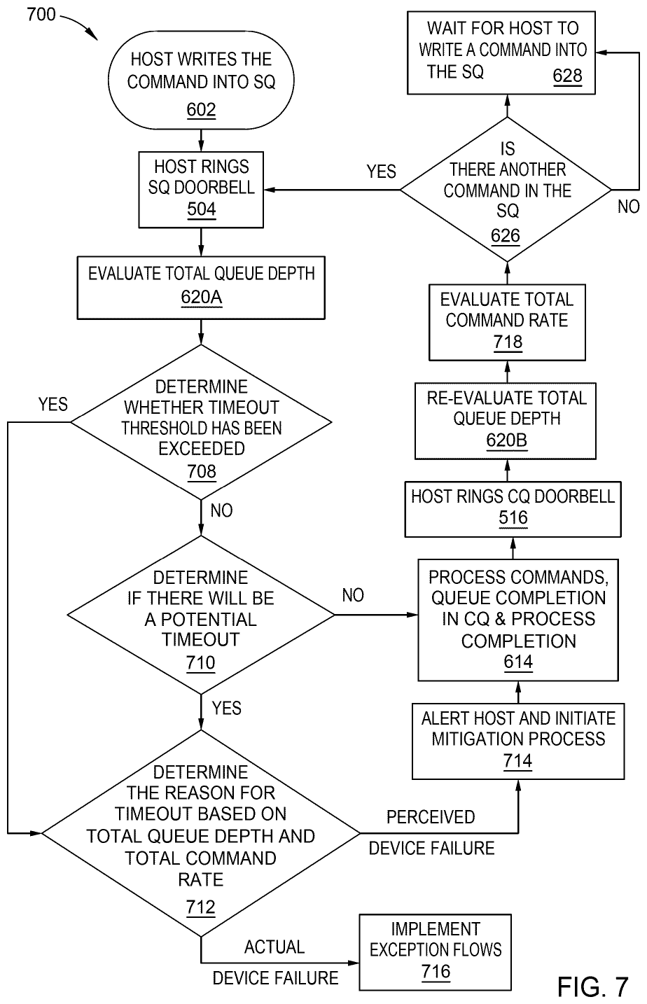

FIG. 7 is a flowchart illustrating a timeout mitigation method 700, according to one or more embodiments. A controller implementing timeout mitigation method 700 is configured to determine whether a timeout or potential timeout is perceived or actual device failure based on evaluating the total queue depth and total command rate of the system. The controller may then alert a host device of the reason of the timeout or potential timeout, so if the device failure is perceived the host can implement appropriate mitigation processes.

Several operations disclosed in FIG. 7 are implementations from FIGS. 2, 5, and 6, and are described above. As shown in FIG. 7, method 700 further includes a determination of timeout or potential timeout (e.g., operations 708, 710); determination of the reason for timeout (e.g., operation 712); alerting the host of the reason for determination and initiation of mitigation processes (e.g., operation 714); and evaluation of the total command rate (e.g., operation 718), which are discussed in detail below.

After process 620A, where the total queue depth is increased when I/O commands are written into the submissions queue, at operation 708, the controller determines whether the timeout threshold set by the operating system has been exceeded. For example, conventional timeout thresholds are typically set between 5 and 30 seconds, up to 60 seconds, regardless of aggregate queue depth. If the timeout threshold has been exceeded, the controller will make a determination of the reason for timeout at operation 712.

In some embodiments, the timeout threshold may be determined by the host device. In which case, the controller will alert the host when the internal estimate of the consumption rate exceeds the host-supplied threshold (e.g., at operation 712). In some embodiments, long-running commands may be failed using a Command Interrupted and Command Retry Delay Mechanism when a timeout threshold is exceeded. In some embodiments, the timeout threshold is defined using a device-internal measurement, or as an offset from the host-supplied threshold. In some embodiments, the timeout threshold may be calibrated as a lesser value than the host-supplied threshold and a fraction of the estimated command latency at the time of the last host-initiated reset, if the last host-initiated reset was performed at a high aggregate queue depth (thus indicating a timeout). For example, if the host-supplied threshold is 10 seconds, then the controller may set a timeout threshold of less than 10 seconds, such as 8 or 9 seconds. In some embodiments, the host may query the controller's up to date command latency estimation via a “get log page” Admin command. For example, after the controller alerts the host (e.g., operation 714) that the estimated patency exceeds a threshold, the host can take measures to reduce load and/or the queue depth, and query the controller for the up to date estimation as a means to check if additional measures should be taken. In some embodiments, the host may continuously or periodically check if the load and/or the queue depth should be increased.

If the timeout threshold has not been exceeded, at operation 710, the controller then determines whether there will be a potential timeout based on the evaluated values for the total queue depth and most recent total command rate, which is calculated at operation 718. If the controller determines that there is no potential for timeout, the controller will proceed to process the commands at operation 614. However, if the controller determines that there will be a potential timeout, at operation 712, the controller will determine the reason for the potential timeout.

At operation 712, the controller will determine the reason for timeout based on the evaluated values for the total queue depth and most recent total command rate. For example, the controller may determine that the reason for the device failure is due to total command rate being less than or equal to the total queue depth. In which case, a host's determination of device failure due the timeout is merely perceived and the controller proceeds to alerting the host of the reason for timeout at operation 714. In another example, the controller may determine that the reason for the timeout is due to actual device failure (e.g., device malfunction). In which case, the host determines that an actual device failure has occurred and the controller will implement exceptions flows for actual device failure at operation 716.

At operation 714, the controller alerts the host of the reason for the perceived device failure. In response to the alert, the host will initiate mitigation processes, such as rate-limiting or redirecting I/O commands to a different device, so that the back-pressure of the host is alleviated and the controller can “catch-up” (e.g., until the command rate is greater than or equal to the total queue depth). During and after initiating mitigation processes to alleviate the back-pressure, I/O commands in the submission queue are continuously being processed by the controller at operation 614. In some embodiments, the controller may receive a notification from the host that mitigation processes are being implemented. In certain embodiments, the controller may be notified that the host is implementing mitigation processes via one or more of the following: receiving a command parameter in an I/O command (i.e., a flag in a read or write command notifying the controller that the host is implementing mitigation processes), receiving a notification that the host is sending a Set Features command with a feature ID that sets a mitigation mode and/or temporarily reduces the command rate target; receiving a sideband notification; or receiving other suitable notification mechanisms. In certain embodiments, upon receiving the notification, the controller may perform one or more of the following: log the notification for future analysis; set a new temporary threshold for the duration of the mitigation process; or reduce internal timeout mitigation activities in line with host-side mitigation.

After the controller re-evaluates the total queue depth by decreasing the total queue depth when I/O commands are executed and written into the completion queue at process 620B, at operation 718, the controller evaluates a total command rate of the controller. That is, the controller calculates the rate that the controller completes I/O commands in the submission queue. For example, the controller may track the number of commands completed for a given timeframe (e.g., within 100 ms). In some embodiments, the host may calculate the total command rate of the controller. However, due to the multiple layering of software at the host side, including the potential for multi-tenant systems, the host hypervisor may not have full visibility of the submission and completion queues. After the total command rate is calculated, the controller checks if there are additional commands in the submission queue at operation 626.

By alerting a host device of the reason for an exceeded timeout threshold or potential timeout, the host is able to implement appropriate mitigation processes for the present circumstance of device failure. The reason of timeout may be determined based on a high queue depth and load, or actual device failure. To make the determination, the storage device may track and evaluate a total queue depth and most recent total command rate to predict an optimal time for the host to implement mitigation processes, such as rate-limiting or redirecting the I/O to a different storage device. The host may also supply a timeout threshold, where the storage device will alert the host when an internal estimate of the consumption rate exceeds the host-supplied threshold.

In one embodiment, a data storage device, including a memory device, and a controller coupled to the memory device, wherein the controller is configured to track a total queue depth of one or more host queues, wherein the total queue depth is a number of pending commands the data storage device can handle at a time, and tracking the total queue depth comprises modifying the total queue depth when at least one command is written to the one or more host queues; and determine whether to alert a host device based on the modified total queue depth.

The controller is further configured to alert the host device based upon the determining. The controller is further configured to receive at least one mitigation measure from the host device, the at least one mitigation measure comprising rate-limiting the host device and redirecting the at least one command to another data storage device. The controller is further configured to track a total command rate of the controller, the total command rate is a number of commands processed by the data storage device per second (IOP/s). Determining whether to alert the host device is further based on the total command rate of the controller. Alerting the host device further comprises determining whether a failure of the data storage device is actual or perceived, wherein the failure is perceived when the total command rate is less than the total queue depth. The controller is further configured to determine whether a timeout threshold has been exceeded, and determine whether the timeout threshold is going to be exceeded. The controller is further configured to alert the host device when the failure of the data storage device is perceived. Tracking the total queue depth of the one or more host queues further includes increasing the total queue depth when the at least one command is written to a first host queue of the one or more host queues; and decreasing the total queue depth when the at least one command is written to a second host queue of the one or more host queues. The first host queue is a submission queue. The second host queue is a completion queue.

In another embodiment, a data storage device, including a memory device, and a controller coupled to the memory device, wherein the controller is configured to track a total queue depth of one or more host queues, wherein the total queue depth is a number of pending commands the data storage device can handle at a time, and tracking the total queue depth including increasing the total queue depth when at least one command is written to a first host queue of the one or more host queues; and decreasing the total queue depth when at least one command is written to a second host queue of the one or more host queues; and determine a reason of a failure of the data storage device based on the total queue depth and a total command rate, wherein the total command rate is a number of commands processed by the data storage device per second (IOP/s).

The first host queue is a submission queue and the second host queue is a completion queue. The reason of the failure of the data storage device is actual or perceived, wherein the failure is perceived when the total command rate is less than the total queue depth, and the controller is further configured to alert a host device when the failure of the data storage device is perceived. The controller is further configured to receive at least one mitigation measure from the host device, the at least one mitigation measure including rate-limiting the host device; and redirecting the at least one command to another data storage device. The controller is further configured to evaluate the total command rate after the at least one command is written to the second host queue.

In yet another embodiment, a data storage device, including means to store data; and a controller coupled to the means to store data, wherein the controller is configured to track a total queue depth of one or more of host queues, wherein the total queue depth is a number of pending commands the data storage device can handle at a time, and tracking the total queue depth includes increasing the total queue depth when at least one command is written to a first host queue of the one or more host queues; and decreasing the total queue depth when at least one command is written to a second host queue of the one or more host queues; determine a reason of a failure of the data storage device based on the total queue depth and a total command rate, wherein the total command rate is a number of commands processed by the data storage device per second (IOP/s); alert a host device based on the determining; and receive at least one mitigation measure from the host device, the at least one mitigation measure including rate-limiting the host device; and redirecting the at least one command to another data storage device.

Tracking the total queue depth includes determining if the at least one command is an Admin command or an I/O command; and increasing a tail pointer of a relevant I/O queue if the at least one command is an I/O command. Tracking the total queue depth further comprises increasing a head pointer of the relevant I/O queue if the at least one command is an I/O command. The controller is further configured to evaluate the total command rate of the controller after the at least one command is written to the second host queue.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device, and
a controller coupled to the memory device, wherein the controller is configured to:
track a total queue depth of one or more host queues, wherein the total queue depth is a number of pending commands the data storage device can handle at a time, and tracking the total queue depth comprises modifying the total queue depth when at least one command is written to the one or more host queues; and
determine whether to alert a host device based on the modified total queue depth.

2. The data storage device of claim 1, wherein the controller is further configured to alert the host device based upon the determining.

3. The data storage device of claim 2, wherein the controller is further configured to receive at least one mitigation measure from the host device, the at least one mitigation measure comprising rate-limiting the host device and redirecting the at least one command to another data storage device.

4. The data storage device of claim 2, wherein the controller is further configured to track a total command rate of the controller, the total command rate is a number of commands processed by the data storage device per second (IOP/s).

5. The data storage device of claim 4, wherein determining whether to alert the host device is further based on the total command rate of the controller.

6. The data storage device of claim 5, wherein alerting the host device further comprises determining whether a failure of the data storage device is actual or perceived, wherein the failure is perceived when the total command rate is less than the total queue depth.

7. The data storage device of claim 4, wherein the controller is further configured to:
determine whether a timeout threshold has been exceeded, and
determine whether the timeout threshold is going to be exceeded.

8. The data storage device of claim 7, wherein the controller is further configured to alert the host device when the failure of the data storage device is perceived.

9. The data storage device of claim 1, wherein tracking the total queue depth of the one or more host queues further comprises:
increasing the total queue depth when the at least one command is written to a first host queue of the one or more host queues; and
decreasing the total queue depth when the at least one command is written to a second host queue of the one or more host queues.

10. The data storage device of claim 9, wherein the first host queue is a submission queue.

11. The data storage device of claim 9, wherein the second host queue is a completion queue.

12. A data storage device, comprising:
a memory device, and
a controller coupled to the memory device, wherein the controller is configured to:
track a total queue depth of one or more host queues, wherein the total queue depth is a number of pending commands the data storage device can handle at a time, and tracking the total queue depth comprises:
increasing the total queue depth when at least one command is written to a first host queue of the one or more host queues; and
decreasing the total queue depth when at least one command is written to a second host queue of the one or more host queues; and
determine a reason of a failure of the data storage device based on the total queue depth and a total command rate, wherein the total command rate is a number of commands processed by the data storage device per second (IOP/s).

13. The data storage device of claim 12, wherein the first host queue is a submission queue and the second host queue is a completion queue.

14. The data storage device of claim 12, wherein the reason of the failure of the data storage device is actual or perceived, wherein the failure is perceived when the total command rate is less than the total queue depth, and
the controller is further configured to alert a host device when the failure of the data storage device is perceived.

15. The data storage device of claim 12, wherein the controller is further configured to receive at least one mitigation measure from the host device, the at least one mitigation measure comprising:
rate-limiting the host device; and
redirecting the at least one command to another data storage device.

16. The data storage device of claim 12, wherein the controller is further configured to evaluate the total command rate after the at least one command is written to the second host queue.

17. A data storage device, comprising:
means to store data; and
a controller coupled to the means to store data, wherein the controller is configured to:
track a total queue depth of one or more of host queues, wherein the total queue depth is a number of pending commands the data storage device can handle at a time, and tracking the total queue depth comprises:
increasing the total queue depth when at least one command is written to a first host queue of the one or more host queues; and
decreasing the total queue depth when at least one command is written to a second host queue of the one or more host queues;
determine a reason of a failure of the data storage device based on the total queue depth and a total command rate, wherein the total command rate is a number of commands processed by the data storage device per second (IOP/s);
alert a host device based on the determining; and
receive at least one mitigation measure from the host device, the at least one mitigation measure comprising:
rate-limiting the host device; and
redirecting the at least one command to another data storage device.

18. The data storage device of claim 17, wherein tracking the total queue depth further comprises:
determining if the at least one command is an Admin command or an I/O command; and
increasing a tail pointer of a relevant I/O queue if the at least one command is an I/O command.

19. The data storage device of claim 18, wherein tracking the total queue depth further comprises increasing a head pointer of the relevant I/O queue if the at least one command is an I/O command.

20. The data storage device of claim 17, wherein the controller is further configured to evaluate the total command rate of the controller after the at least one command is written to the second host queue.
